(19) United States
(12) Patent Application Publication
(10) Pub. No.: US 2012/0046890 A1
(43) Pub. Date: Feb. 23, 2012

(54) ENERGY MONITORING DEVICE

(76) Inventors: RICKY JEFF PENNINGTON, EAGLE, ID (US); DEREK JOHN GABLE, RANCHO PALOS VERDES, CA (US); ADAM JUSTIN HIEB, MERIDIAN, ID (US)

(21) Appl. No.: 13/211,967

(22) Filed: Aug. 17, 2011

Related U.S. Application Data
(60) Provisional application No. 61/374,379, filed on Aug. 17, 2010.

(51) Int. Cl. G06F 19/00

(52) U.S. Cl. 702/61

(57) ABSTRACT

Disclosed is an electrical monitoring device which uses a predictive algorithm for projecting a likely energy cost for an appliance. The current power usage of an attached appliance is measured, and combined with past power usages, and projected energy consumption based on usage trends is calculated, and displayed by an array of multiple LED lights, with different colors indicating different consumption ranges. Projected energy costs are calculated from information included in a cost look-up chart.

### PRIORITY/CROSS-REFERENCE TO RELATED APPLICATIONS

This application claims the benefit of U.S. Provisional Application No. 61/374,379, filed Aug. 17, 2010, the disclosure of which is incorporated by reference.

### TECHNICAL FIELD

The presently disclosed and claimed inventive concept(s) generally relates to a device or method for monitoring energy utilized, and more particularly to a device and method for monitoring energy usage and making projections of future energy bills based on an averaging of historical and current usage levels and information about regional energy prices.

### BACKGROUND

It is desirable for a consumer to monitor the energy usage of appliances in his house, in order to monitor his energy usage and to learn how to reduce his usage and thereby reduce his utility bill. There are a number of devices which plug into a household outlet, and which provide an outlet on the front face for an appliance to be plugged in. Most of these are simply meters, and they meter the amount of energy that is being used by the appliance that is plugged into the monitor. The results of the metering can be shown as a needle on a dial, or they can be indicated by the use of LED light bulbs. To monitor an instantaneous current usage by LED's, a single LED might be utilized which comes on if an appliance exceeds a certain electrical usage. Also, multiple LED's can be utilized with each LED indicating a different level of usage, in increments selected by the designer of the instrument. For instance, if there were five LED's, and four of the LED's were lit, that might tell the consumer how much power is being drawn at that time.

With an energy sensing device such as these, which make up most, if not all, of the prior art, one really only needs to have one of these devices, plug it in for each of his appliances such as a room light, stereo, refrigerator, or any other appliance in the house. When the appliance is turned on, the device will tell the user how much power that appliance is consuming. This kind of energy monitoring is an indicator of how much power an appliance is pulling when it is turned on. The prior art devices don't show a forecasted cost that is based on a weighted average of historical and recent usage patterns. Some appliances may pull a variable amount of power so using an instantaneous type of monitor to do continuous monitoring is of limited value. If a person wanted to use this kind of monitor, he could use one to get a rough idea of what all his appliances consume. This is not bad information to have, but a more useful kind of information is one which tracks trends of usage and makes an estimate of what the energy cost for the selected appliance will be on the next power bill. A device which operates in this manner is different from the prior art because it is not an instantaneous meter, it has predictive calculations, and through a simplified visual display methodology it provides the user with highly personalized or localized information that can be used to help change a user's energy consumption habits and decrease his utility bill.

### SUMMARY

The invention is a device which plugs into a wall outlet and has receptacles in the device body so that an appliance may be plugged into the device. The device monitors the power being used by the appliance which is plugged into the device body and gives consumers an indication of power usage. The device includes a monitoring circuit to sense how much electricity the electrical appliance is using. It monitors the electrical usage of the appliance for a period of time, and thus includes a sampling algorithm for real time energy use. From the sampling information, both real time and historical, a forecasting algorithm is used to project the monthly total energy that will be used by that appliance. The device uses a weighted average, so that if the consumer begins using less electricity in that appliance, the forecasted energy usage for the month will decrease.

The device includes a visual display of energy use, which can be in the form of a number of LED indicators. This can be in the form of a horizontal or vertical row of LED indicators which can be five, six, or seven LED indicators, for example. Each of the LED indicators can have multiple colors, so a single row of LED indicators can display information in several ranges of energy usage. For instance, the first range may activate the LED indicators with green lights so that several of the LED indicators are lit, and several are not lit. Typically, the lower usage of energy would be indicated by LED indicators to the left or bottom of the row and the higher energy usages would be indicated by LED indicators on the right or top of the row. If the entire row of LED indicators were activated and displayed as green lights all across the row, but energy usage was projected to be higher than the row of green LEDs, then the green LEDs would go out and another color would be activated, such as yellow. These different levels of power usage can be displayed by the use of multiple rows of different colored LEDs, but the disclosed technology utilizes a row of multicolored LEDs for compactness and simplicity. When all of the LED indicators had been activated in the yellow level, another color indicating a higher level of consumption could be activated, such as red. If the energy used by the appliance is projected to be higher than the highest red indicator, then all the red LEDs could be activated or could be flashing indicating that the energy use is above the available scale.

A step midway between LED indicators could be indicated by the blinking of an LED indicator, generally the right most LED in a row or the top most LED in a column, when the energy usage is halfway to the next level. The LED indicators can be positioned on the corner of the device body, and if L shaped, would be visible from straight on, as well as from the top.

The device is provided with a look-up table, so that a consumer may look up what the cost of the energy used will be if four of the green indicators, or if two of the yellow indicators are activated for instance, or if all of the red indicators are activated.

A possible way to update the look-up table for the device, if embedded inside of the device in nonvolatile memory, is to provide a USB or other electrical connection to a computer, or to provide a wireless connection to a computer, with the look up table updated from a signal from the computer. The look up table might also be provided with manual update capability. It would typically be set at the factory for a geographic region in which it is expected to be used. The look-up table would contain rates being charges for electricity in a designated region. The programmable information could also include the quanta of energy consumption represented by each LED (for example 10 KWHrs/LED or 100 KWHRs/LED, etc.).

It is important to understand that the energy use displayed by the device is not an instantaneous power consumption read out. It is a projected energy usage for a period of time, such as a month, and gives the consumer an indication of the dollars per month that running an appliance is projected to cost. Changes in the use pattern of the appliance will result in the forecasted cost going up or down. It is believed that merely giving the consumer information about energy usage and costs will give the consumer a tool by which to change his use pattern on an appliance, and therefore lower his energy consumption and his expenditures on energy usage.

The device in one version is approximately two and one half inches by two and one half inches by two inches, and plugs into a wall outlet. On the front face of the device body an electrical receptacle is provided, into which an electrical appliance may be plugged. It would typically operate at 115 to 125 volts AC, and would typically have a maximum current of 15 amps. Other versions of the device could operate with higher voltage and more current, depending on the particular application. The device could be made to show different granularity, such as 5, 10, or 100 kwh/month per LED.

The invention can also include a method of monitoring and displaying energy use which includes the following steps:
1. Monitoring the power consumption at an outlet for a selected period of time to establish a consumption baseline.
2. Comparing the forecasted consumption to the baseline that was previously captured.
3. Providing a visual indication as to whether a consumption forecast is above, below, or on track with the baseline.

The method can include the step of providing a visual indicator in the form of a row, either horizontal or vertical, or bar of LED indicators, including a plurality of LED indicators. This could include multiple indicators such as 3, 4, 5, 6, 7, or more indicators in the row. The indicator can also be in the form of a spot, to represent an energy hot spot. The spot can grow larger and change color as the consumption of energy exceeds the baseline. Any of these methods would provide not only a quantitative, but also a qualitative visual feedback clue to the consumer about energy consumption at a particular outlet.

1. Another version of the device has a visual indicator which glows when an energy target is exceeded, and stops glowing when energy consumption drops below the user target.
2. Another wireless version with an internal relay and radio component, includes a remote control which provides on/off reset function for each module. The remote operates within 30 to 50 feet of each module and does not require line of sight operation. The remote provides a reset of each module's energy target without unplugging the device. The remote can have each module button identified with the outlet it is set to operate with, with typical labels being, “Entertainment System,” “Office Equipment,” “Space Heater,” etc.
3. Another embodiment of the device is one which includes a simple four button navigation mode. It includes an LCD which displays relevant measurements and settings such as: Energy Rate, Profiling Time, Dollars/Month, Kw/Hour, Target Monthly Cost. As with all of the units, this embodiment involves sensing energy use and forecasting, based on weighted real time as well as historical use, the projected use for a period of time, such as a month.

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the inventive concept(s) of the application, which is measured by the claims, nor is it intended to be limiting as to the scope of the inventive concept(s) in any way.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 is a perspective view of the front side of an embodiment of the technology.

FIG. 2 is a perspective view of the back side of an embodiment of the technology.

FIG. 3 flow chart of an embodiment of the technology.

FIG. 4 is a front view of an embodiment of the technology.

FIG. 5 is a perspective view of a remote control of the technology.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

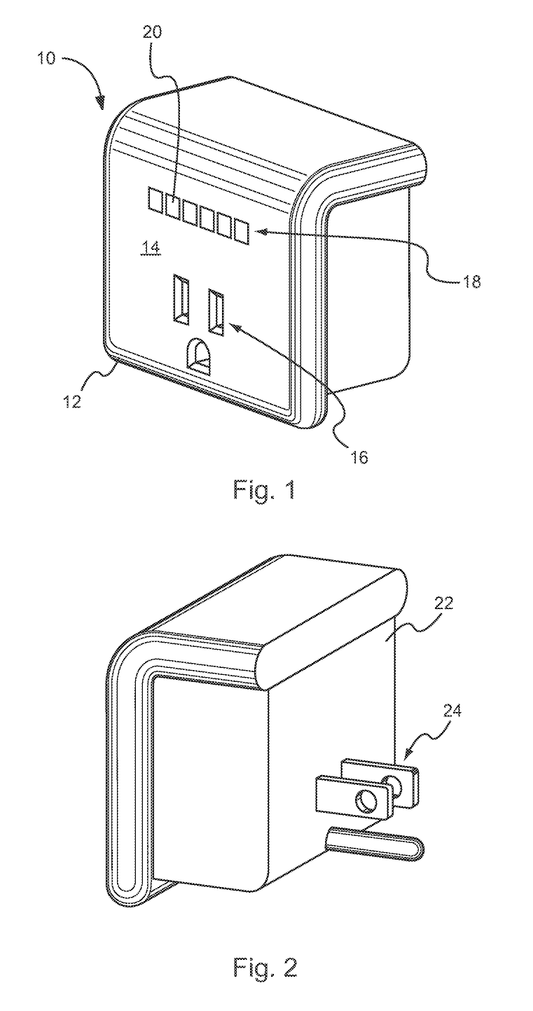

Shown in FIGS. 1 through 5 are several preferred embodiments of the device of the electrical monitoring device 10.

Shown in FIG. 1 is a generally cubicle version of the device 10, which includes a device body 12, a front side 14, electrical receptacle 16, a bank of LEDs 18 and a number of individual LED lights 20. This version of the device includes electrical inserts 24 which are on the back side 22 of the device 10. The device 10 is plugged into a wall outlet, and then an appliance or power strip may be plugged into the electrical receptacle 16 for monitoring. The device monitors the amount of electrical energy which the appliance utilizes over a period of time. After an initial period of time has passed in which data is accumulated and stored in a memory device, newly occurring usage data are combined with past recorded usage data to arrive at a projected cost of electricity if previous usage patterns are continued. This projected utility cost is displayed in the LED lights and multiple colored LED lights are utilized to show different ranges and levels of projected energy usage. For instance, illuminating LEDs green could be utilized to show increasing levels of consumption within a certain window of projected power usage, and when that window had been reached or exceeded, the LED lights would switch to a different color, such as yellow, and the number of LED lights illuminated would indicate projected energy uses within the yellow window of energy predictions. A third or even more colors of LED lights would be used to represent other consumption windows, with the LED lights showing project energy usage.

The more “weight” you put on the most recent behaviors, the more quickly the user can see the impact of their savings behaviors. Conversely, if they start to consume more energy than when they started the profiling exercise, the higher their forecasted energy cost will be. It's a balance between giving the user a credible projected cost and giving them as much “instant/real-time” feedback as possible.

Shown in FIG. 3 is a logic diagram of the operation of the electrical monitoring device 10. For the purposes of this description the term “unit” can be physical (like a separate hardware unit) or logical (combination of hardware and firmware or just firmware). Shown in FIG. 3 is an electrical receptacle 16 which is connected to electrical inserts or plugs 24 on the opposite side of the device. A monitoring unit 26 measures the amount of power that is being utilized by an appliance plugged into the electrical receptacle 16. This value is sent to a memory unit 28 where the amount of power utilized at different times in present and past is recorded in the memory unit 28. The data in the memory unit 28 is acted upon by a calculation unit 30, which uses a weighted average type algorithm 32 in order to generate a value at 34 in the form of an electrical signal which is sent on to an LED control unit 36. Based upon the electrical signal value from the calculation unit, the LED signal generator 36 will send a signal to one or more of the LED's 20. Preferably the LED's will light from left to right or top to bottom to indicate an increasing predicted value of electricity usage and cost, which is the result of calculations based on past and present usage patterns. When the LED indicating the highest usage of a certain level is reached, then a second level is begun with LED's of different colors indicating projected values of higher electrical usages. A third or even more levels are available and would be represented by different colors of LED. A look-up table 38 may be present internal to the device, with values which may be set at the factory with the rates being charged for electricity in a certain region of the selected country. The look-up table may also be a printed look-up table which allows the consumer to easily determine the projected cost. The printed version is an alternative to the digital version. Shown at 46 is a time tracking unit used by the power monitoring unit.

The information in the printed lookup table is correlated to the number of LEDs lit, and the color of LEDs lit. The combination of color and number of LEDs define the projected cost of electricity.

The internal look up table, if present, can be set at the factory, or updated by the user, such as by a USB port 48, by a wireless signal from a handheld computing device or a lap top or by manual means of input, such as an capacitive touch screen or similar technology. The technology can incorporate a variety of LED systems with varying granularity and/or color to indicate the power use and cost during any given period of time.

A self-calibration unit is included in which a no load voltage measurement sample is taken and used to calibrate other voltage measurements. The no load sample is used to eliminate offsets and unit-to-unit variations common in voltage measurement circuits.

One version of the device includes 6 “Consumption” LEDs, and one Range LED. Any number of LED indicators could be used, and one example is a 6 LED display. Each of these LEDs can be illuminated one of three colors (green, yellow, and red). That provides 18 cost indications. As an example of how these LEDs would work, at 5 KWhrs/month per LED, the device can measure appliances and devices that will consume up to 90 KWHrs/month or around $9.90/month using a national energy rate of $0.11/KWHr. Of course there are devices and appliances that can/will consume more than that and it is desirable to be able to handle those. To accomplish that a Range LED is used. As an example, when in the first range or low range, when the Range LED is illuminated green, the device is tracking attached devices or appliances that are consuming from 0 up to 90 KWhrs/month, when all 6 LEDs are illuminated solidly, or up to $9.90/month. When the Range LED moves from green to yellow, this means the attached device or appliance is projected to consume between 95 and 180 KWHrs/month or resulting in a cost of $10.45/month to $19.8/month. When the Range LED is yellow, the Consumption LEDs will start over again being illuminated green, then yellow, then red. Each Consumption LED in the yellow range is still worth 5 KWhr/month in our current implementation. This is somewhat arbitrary and each light could represent 5, 10, or 100 KWHr/month. If the attached appliance consumes more than 180 KWHrs/month, the Range LED moves to red or the high range and the Consumption LEDs start over again being illuminated first green, then yellow, then finally red. In each Range (low, medium, and high) we can display 18 incremental amounts of energy consumption if the implementation uses 6 Consumption LEDs.

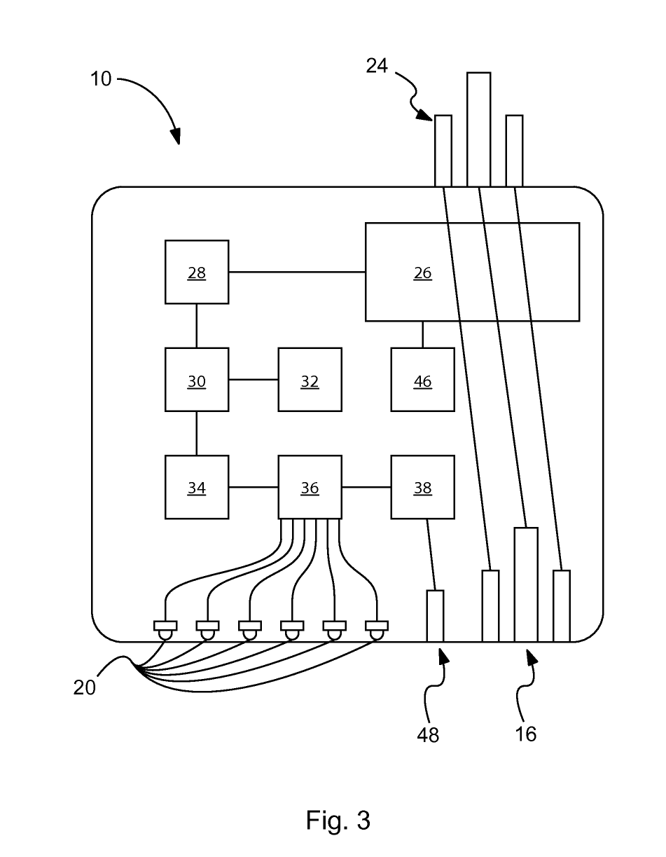

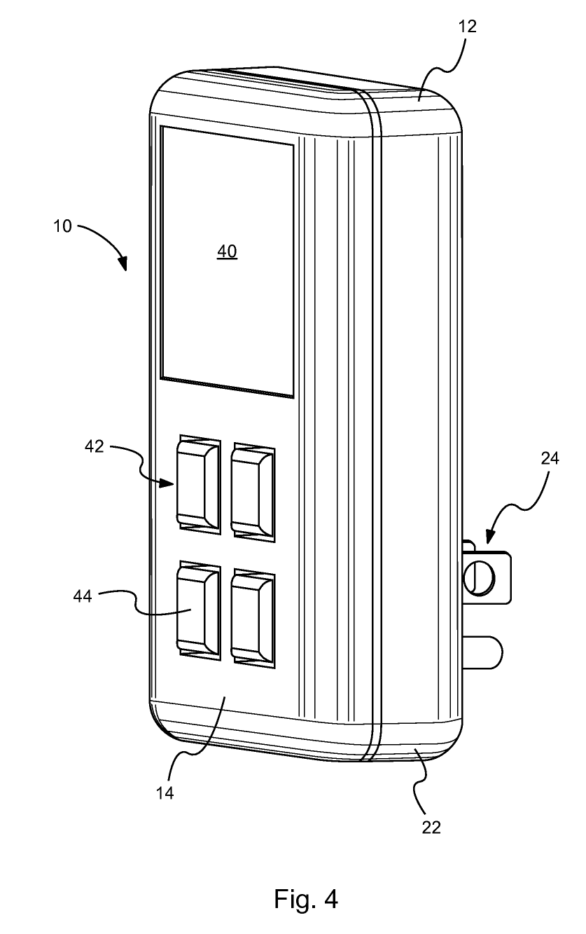

Shown in FIG. 4 is an embodiment of the electrical monitoring device 10 in which the device body 12 is made up of a front side 14 and a back side 22. In this embodiment of the device, the front side and the back side slide apart to expose an electrical receptacle 16, which is not shown in this view. Once the front side and the back side are slid apart, an appliance may be plugged in to the electrical receptacle located on the front face of the back side and the device would work in the same manner as previously described. Shown in this embodiment is a view screen 40 on which messages and information may be displayed. The device also includes a key pad 42, in this case, made up of four menu navigation buttons 44. The view screen 40 is utilized to display settings and measurements concerning the energy rate, profiling time, dollars per month projection, kilowatt hours and the target monthly cost. This can be displayed in text fields or in a display equivalent to the bank of LEDs 18 which is shown in FIGS. 1 and 2. This configuration of the device would preferably include battery backup for data retention when the device is removed from the electrical outlet. For the purpose of recovering data, non-volatile memory would be utilized.

All of these embodiments would include a time tracking unit 46 for associating actual usage information with a particular time period. The device shown in FIG. 4 has the advantage of providing a place for a color panel, which would be made visible when the front and the back halves are slid apart. This unit is designed to be a user friendly energy monitoring and forecast product. It is a non-threatening way for the consumer to assess what is being spent on electronic products in the home. After plugging this device into a standard wall outlet, an electronic device or appliance is plugged into the electrical receptacle on the face of the device. Forecasted power is automatically calculated and displayed after an assessment period.

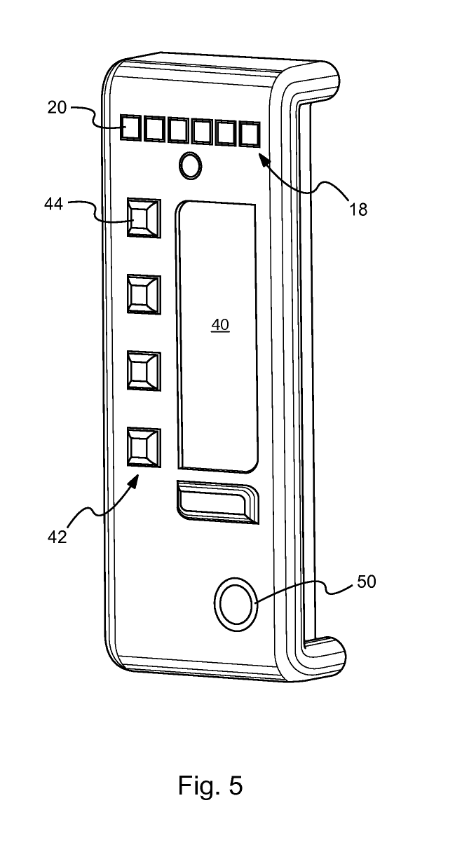

FIG. 5 shows a version of the disclosed device. The device shown in FIG. 5 has a combination of figures from the device in FIGS. 1 and 4. The device shown in FIG. 5 has an area 40 of the enclosure upon which adhesive labels are placed to indicate what type of wireless module they are communicating with when they use the remote to control the module. The device can also be constructed with a view screen. The device in FIG. 5 includes a bank of LED lights 18, with individual LED lights 20 for signaling projected electric values. Also present in the version in FIG. 5 is a Range LED as well as LED indicators which represent incremental consumption with a particular range of energy use. The Range LED serves the purpose of defining the value represented by each of the Consumption LEDs. The Consumption LEDs represent a quantity of projected power cost within the range indicated. The LED lights 20 of the device of FIG. 5 would also be configured to display different colors, such as three colors, to indicate three levels of projected energy usage. The device of FIG. 5 also has navigation buttons 44 in a key pad 42. The versions of the device shown in FIG. 1 or other versions could also have a Range LED (not shown). The device in FIG. 5 includes a reset button 50 for each wireless module.

Alternatively an embodiment of the invention can be built into an appliance such as to be a part of the appliance. This includes, for example, power monitoring and display units built into the handle of a power tool or in the door of a refrigerator or other large appliance. This would avoid the necessity of having to plug the invention into a wall outlet and obviate the necessity of having electrical prongs on the invention.

While certain exemplary embodiments are shown in the Figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. An energy use display device for monitoring energy consumption of an electrical appliance, comprising:
a device body comprising a housing with a front side and a back side, with protruding electrodes for insertion into a wall outlet, with said device body further comprising electrode receiving wells equivalent to a wall outlet, for electrical plug-in of an electrical appliance to be monitored;
a monitoring circuit to sense how much electricity said electrical appliance is using;
a time tracking unit to aid in energy monitoring
a memory unit to record historical energy usage;
a forecasting unit to project the monthly use of electricity of said appliance based on measured energy usage of said appliance for a period of time;
a visual display of energy use projection of said appliance, comprising a plurality of LED indicators, with each LED indicator corresponding to an amount of electricity projected to be used in a month.

2. The energy use display device of claim 1 in which said energy use projection is determined using a weighted average of historical energy usage with recent usage more heavily weighted than older energy usage.

3. The energy use display device of claim 1 in which said LED indicators are arranged in a row on said device body, with lower use indicated by fewer LED indicators being activated, and higher energy use indicated by more LED indicators being activated.

4. The energy use display device of claim 1 which further comprises a lookup table with energy rates per energy unit, for calculation is a dollar value of projected energy use based on the calculated projection of energy usage.

5. The energy use display device of claim 4 in which said lookup table is digital and internal to the device.

6. The energy use display device of claim 4 in which said lookup table is comprised of printed matter which a user may use to calculate projected energy costs based on the LEDs activated.

7. The energy use display device of claim 3 which further comprises LED indicators capable of displaying multiple colors, with said LED indicators configured to activate in one color until the LED indicator showing maximal usage is activated, then to reset to inactive and to begin activating in a next color to indicate energy usage in a second range, with multiple colors for indicating multiple ranges of energy usage.

8. The energy use display device of claim 7 in which the LED indicators for lesser usage remain activated while the currently projected usage is activated, so a whole bank of LEDs may be activated for any particular range of usage, with multiple LEDs activated simultaneously.

9. The energy use display device of claim 7 in which said LED indicators are configured for displaying three colors and to activate one at a time until all LEDs of a predetermined color are activated, with a first color indicating a first range of energy usage, a second color indicating a second and higher range of energy usage, and a third color indicating a third and higher range of energy usage.

10. The energy use display device of claim 7 which further comprises a remote monitor which a user may view at a location remote from said device.

11. The energy use display device of claim 10 which further comprises a function for viewing multiple devices from a remote location from said device.

12. A method of monitoring and displaying energy use comprising the steps of:
monitoring the power consumption of an appliance at an outlet for a selected period of time, to establish a consumption baseline, and storing said power consumption data and baseline in memory;
combining the forecast baseline with current or recent consumption by use of a forecasting algorithm to project an energy consumption forecast;
comparing the consumption forecast to said baseline that was previously captured; and
providing a visual indication representative of projected energy costs.

13. The method of claim 12 in which a visual indication is presented as to whether the consumption forecast is above, below, or on track with the baseline or a previously defined consumption target.

14. The method of claim 12 in which energy forecasts are based on a usage of energy of a period of one month.

15. The method of claim 12 which includes the step of providing visual indication in the form of a row or bar of LED indicators, including an visual indicator that indicates consumption exceeding a preselected target.

16. The energy use display device of claim 1 in which said monitoring circuit includes a self-calibration method that uses a no load voltage measurement sample to improve the accuracy of loaded voltage measurements.

17. An energy use display device for monitoring energy consumption of an electrical appliance, comprising:
a device body comprising a housing with protruding electrodes for insertion into a wall outlet, with said device body further comprising electrode receiving wells equivalent to a wall outlet, for electrical plug-in of an electrical appliance to be monitored;
a monitoring circuit to sense how much electricity said electrical appliance is using;
a time tracking unit to aid in energy monitoring
a memory unit for storing past measurements of energy usage;
a forecasting unit to calculate and project a predicted monthly use of electricity of said appliance based on measured energy usage of said appliance for a period of time, with recent usage given more weight in said calculation;
a visual display of energy use projection of said appliance, comprising a plurality of multicolor LED indicators, with each LED indicator corresponding to an amount of electricity projected to be used in a month, and with each color indicating a different range of values, so that said LED indicators display a first color until that range is exceeded, then a second color until that range is exceeded, and a third color for a third range of values;
a multi color range indicator for indicating a different range for the LED indicators, so that when a first color is shown in the range indicator, the ranges of values for the colors of the LED indicators are at a first level, and when a second or other color is shown on the range indicator, the values represented by the LED indicators are a second and higher range of values.

18. The energy use display device of claim 6 wherein said LED indicator lights comprise at least two colors, wherein said energy user uses the activated indicator LED lights in association with a color of said activated indicator lights to calculate said projected energy use costs.
